(19) United States
(12) Patent Application Publication
(10) Pub. No.: US 2015/0370934 A1
(43) Pub. Date: Dec. 24, 2015

(54) COMPLETION DESIGN BASED ON LOGGING WHILE DRILLING (LWD) DATA

(71) Applicant: Schlumberger Technology Corporation, Sugar Land, TX (US)

(72) Inventors: Stephen W. Pride, Stavanger (NO); Christophe Dupuis, Sandnes (NO)

(21) Appl. No.: 14/747,201

(22) Filed: Jun. 23, 2015

Related U.S. Application Data
(60) Provisional application No. 62/016,380, filed on Jun. 24, 2014.

(51) Int. Cl. G06F 17/50; E21B 49/08

(52) U.S. Cl. CPC G06F 17/5009; E21B 49/087

(57) ABSTRACT

A method, apparatus, and program product utilize logging while drilling (LWD) data, e.g., structural data, formation property data, fluid contact data and/or structural dip data as may be derived from resistivity and/or other LWD data, to generate a locally enhanced reservoir model of a reservoir proximate a wellbore. The locally enhanced reservoir model, in turn, may be used to optimize the design of a completion for the wellbore, e.g., by optimizing the design of a flow control device incorporated into such a completion.

### CROSS-REFERENCE TO RELATED APPLICATIONS

This application claims the filing benefit of U.S. Provisional Patent Application Ser. No. 62/016,380 filed on Jun. 24, 2014, which is incorporated by reference herein in its entirety.

### BACKGROUND

Among other issues, high water production can become an issue in horizontal oil wells, especially in longer laterals, generally because of the high drawdown difference or variation from the heel to toe. In addition, the presence of heterogeneity along a lateral section can in some instances lead to uneven sweep of hydrocarbons, which can result in poor recovery. To control water production and achieve better sweep efficiency, flow control devices have been introduced to balance fluid flux along a producing/injecting horizontal well.

Flow control devices include passive devices such as Inflow Control Devices (ICDs) as well as active devices such as Inflow Control Valves (ICVs) and autonomous devices such as Autonomous Inflow Control Devices (AICDs), among others. Flow control devices are often incorporated into well completions that are installed within a wellbore to control production.

Prior to drilling of a well, a well plan is generally developed, so that the well is drilled according to that plan. The well plan may also incorporate plans for a well completion, which, particularly for horizontal wells, may further include one or more flow control devices that will be installed in the completion to control the fluid flow throughout the well completion. The well plan may include, for example, a proposed design for one or more flow control devices, e.g., positions or depths along the wellbore, nozzle sizes/flow areas, packer locations, number of ICDs or AICDs per compartment, etc.

A well plan can impact the production capability of a well, and accordingly, substantial efforts have been directed toward optimizing the development of well plans. Well plans, in many cases, are developed with the assistance of reservoir simulators that model the structure and/or properties of a reservoir and help with predicting a proper trajectory and placement of a wellbore to optimize production. Completions, as well, may be designed with the assistance of such tools, again with the goal of optimizing production.

Nonetheless, it has been found that reservoir simulation can be an inexact science, particularly in areas of a reservoir where no wellbores currently exist, due to the relatively low resolution of many reservoir mapping techniques such as seismic surveying. As a consequence, well plans, as well as the design of completions and any flow control devices incorporated therein, may ultimately be based upon faulty assumptions made about the composition of a reservoir. Therefore, a need continues to exist in the art for a manner of improving the design of well completions and/or flow control devices used in well completions.

### SUMMARY

The embodiments disclosed herein provide a method, apparatus, and program product that utilize logging while drilling (LWD) data, e.g., structural data, fluid contact data and/or structural dip data as may be derived from resistivity and/or other LWD data, to generate a locally enhanced reservoir model populated with rock and fluid properties of a reservoir proximate a wellbore. The locally enhanced reservoir model, in turn, may be used to optimize the design of a completion for the wellbore.

Therefore, consistent with one aspect of the invention, completion design is performed by receiving logging while drilling (LWD) data collected during drilling of a wellbore into a reservoir, generating a locally enhanced reservoir model of at least a portion of the reservoir proximate the wellbore based upon the received LWD data, and optimizing a design of at least one completion for the wellbore based upon the generated locally enhanced reservoir model.

In some embodiments, the LWD data includes resistivity data collected from a deep directional resistivity too, in some embodiments, the LWD data includes structural data and/or fluid contact data generated from an inversion of an output of the deep directional resistivity tool, and in some embodiments the LWD data includes structural dip data. In some embodiments, the locally enhanced reservoir model is generated from a near well structural model.

In addition, in some embodiments, optimizing the design includes varying a depth and/or a flow area for at least one flow control device in the at least one completion, changing a number of flow control devices and/or completions or changing a location of a flow control device and/or a completion based upon the generated locally enhanced reservoir model. In some embodiments, optimizing the design further includes automatically and iteratively varying the design, running a simulation using the varied design and comparing a result of the simulation based upon an objective function, and in some embodiments, optimizing the design includes changing a water contact height based upon the generated locally enhanced reservoir model. Some embodiments also include in an execution phase using the generated locally enhanced reservoir model to refine a reservoir model used to generate an initial well plan for the wellbore during a planning phase, and where optimizing the design includes refining an initial design generated during the planning phase using the reservoir model. Further, in some embodiments generating the locally enhanced reservoir model includes populating a structural model with one or both of formation and fluid properties.

In addition, some embodiments include an apparatus at least one processing unit and program code configured upon execution by the at least one processing unit to perform any of the aforementioned methods. Some embodiments also include a program product including a computer readable medium and program code stored on the computer readable medium and configured upon execution by at least one processing unit to perform any of the aforementioned methods.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a block diagram of an example hardware and software environment for a data processing system in accordance with implementation of various technologies and techniques described herein.

FIGS. 2A-2D illustrate simplified, schematic views of an oilfield having subterranean formations containing reservoirs therein in accordance with implementations of various technologies and techniques described herein.

FIG. 3 illustrates a schematic view, partially in cross section of an oilfield having a plurality of data acquisition tools positioned at various locations along the oilfield for collecting data from the subterranean formations in accordance with implementations of various technologies and techniques described herein.

FIG. 4 illustrates a production system for performing one or more oilfield operations in accordance with implementations of various technologies and techniques described herein.

FIG. 5 illustrates an example multi-segmented model for use in generating a completion design in accordance with implementations of various technologies and techniques described herein.

FIG. 6 illustrates an example well-centric, log derived properties workflow for use in a planning phase of a completion design generation process in accordance with implementations of various technologies and techniques described herein.

FIG. 7 illustrates an example well-centric, geologically derived properties workflow for use in a planning phase of a completion design generation process in accordance with implementations of various technologies and techniques described herein.

FIG. 8 illustrates an example reservoir-centric workflow for use in a planning phase of a completion design generation process in accordance with implementations of various technologies and techniques described herein.

FIG. 9 illustrates an example model generation workflow for use in an execution phase of a completion design generation process in accordance with implementations of various technologies and techniques described herein.

FIG. 10 illustrates an example completion design generation workflow in accordance with implementations of various technologies and techniques described herein.

### DETAILED DESCRIPTION

The herein-described embodiments provide a method, apparatus, and program product that utilize logging while drilling (LWD) data, e.g., structural data, fluid contact data and/or structural dip data as may be derived from resistivity and/or other LWD data, to generate a locally enhanced reservoir model of a reservoir proximate a wellbore. The locally enhanced reservoir model, in turn, may be used to optimize the design of a completion for the wellbore.

### Hardware and Software Environment

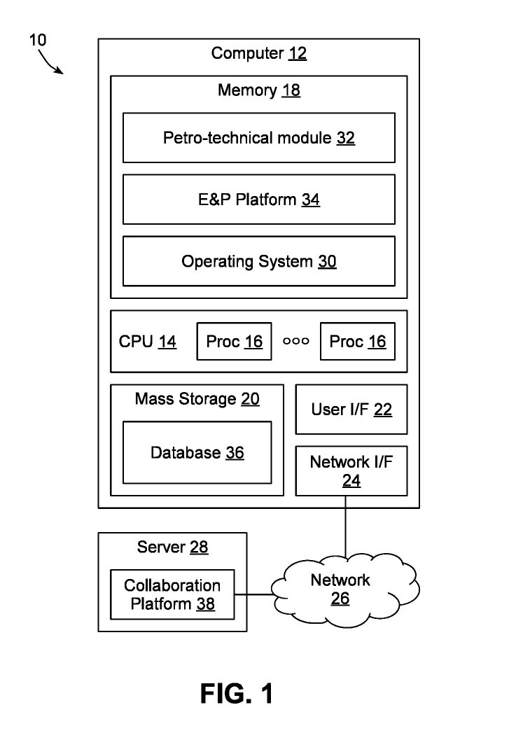

Turning now to the drawings, wherein like numbers denote like parts throughout the several views, FIG. 1 illustrates an example data processing system 10 in which the various technologies and techniques described herein may be implemented. System 10 is illustrated as including one or more computers 12, e.g., client computers, each including a central processing unit (CPU) 14 including at least one hardware-based processor or processing core 16. CPU 14 is coupled to a memory 18, which may represent the random access memory (RAM) devices comprising the main storage of a computer 12, as well as any supplemental levels of memory, e.g., cache memories, non-volatile or backup memories (e.g., programmable or flash memories), read-only memories, etc. In addition, memory 18 may be considered to include memory storage physically located elsewhere in a computer 12, e.g., any cache memory in a microprocessor or processing core, as well as any storage capacity used as a virtual memory, e.g., as stored on a mass storage device 20 or on another computer coupled to a computer 12.

Each computer 12 also generally receives a number of inputs and outputs for communicating information externally. For interface with a user or operator, a computer 12 generally includes a user interface 22 incorporating one or more user input/output devices, e.g., a keyboard, a pointing device, a display, a printer, etc. Otherwise, user input may be received, e.g., over a network interface 24 coupled to a network 26, from one or more external computers, e.g., one or more servers 28 or other computers 12. A computer 12 also may be in communication with one or more mass storage devices 20, which may be, for example, internal hard disk storage devices, external hard disk storage devices, storage area network devices, etc.

A computer 12 generally operates under the control of an operating system 30 and executes or otherwise relies upon various computer software applications, components, programs, objects, modules, data structures, etc. For example, a petro-technical module or component 32 executing within an exploration and production (E&P) platform 34 may be used to access, process, generate, modify or otherwise utilize petro-technical data, e.g., as stored locally in a database 36 and/or accessible remotely from a collaboration platform 38. Collaboration platform 38 may be implemented using multiple servers 28 in some implementations, and it will be appreciated that each server 28 may incorporate a CPU, memory, and other hardware components similar to a computer 12.

In one non-limiting embodiment, for example, E&P platform 34 may implemented as the PETREL Exploration & Production (E&P) software platform, while collaboration platform 38 may be implemented as the STUDIO E&P KNOWLEDGE ENVIRONMENT platform, both of which are available from Schlumberger Ltd. and its affiliates. It will be appreciated, however, that the techniques discussed herein may be utilized in connection with other platforms and environments, so the invention is not limited to the particular software platforms and environments discussed herein.

In general, the routines executed to implement the embodiments disclosed herein, whether implemented as part of an operating system or a specific application, component, program, object, module or sequence of instructions, or even a subset thereof, will be referred to herein as “computer program code,” or simply “program code.” Program code generally comprises one or more instructions that are resident at various times in various memory and storage devices in a computer, and that, when read and executed by one or more hardware-based processing units in a computer (e.g., microprocessors, processing cores, or other hardware-based circuit logic), cause that computer to perform the steps embodying desired functionality. Moreover, while embodiments have and hereinafter will be described in the context of fully functioning computers and computer systems, those skilled in the art will appreciate that the various embodiments are capable of being distributed as a program product in a variety of forms, and that the invention applies equally regardless of the particular type of computer readable media used to actually carry out the distribution.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, DVD, or other optical storage, magnetic cassettes, magnetic tape, magnetic disk storage or other magnetic storage devices, or any other medium that can be used to store the desired information and which can be accessed by computer 10. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Furthermore, it will be appreciated by those of ordinary skill in the art having the benefit of the instant disclosure that the various operations described herein that may be performed by any program code, or performed in any routines, workflows, or the like, may be combined, split, reordered, omitted, and/or supplemented with other techniques known in the art, and therefore, the invention is not limited to the particular sequences of operations described herein.

Those skilled in the art will recognize that the example environment illustrated in FIG. 1 is not intended to limit the invention. Indeed, those skilled in the art will recognize that other alternative hardware and/or software environments may be used without departing from the scope of the invention.

### Oilfield Operations

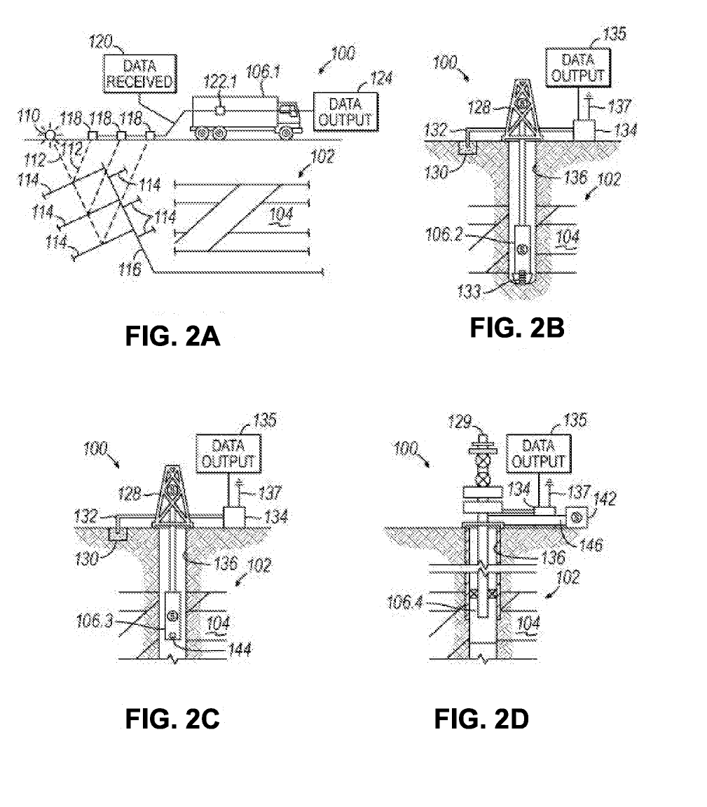

FIGS. 2A-2D illustrate simplified, schematic views of an oilfield 100 having subterranean formation 102 containing reservoir 104 therein in accordance with implementations of various technologies and techniques described herein. FIG. 2A illustrates a survey operation being performed by a survey tool, such as seismic truck 106.1, to measure properties of the subterranean formation. The survey operation is a seismic survey operation for producing sound vibrations. In FIG. 2A, one such sound vibration, sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 2B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud may be filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Generally, the wellbore is drilled according to a drilling plan that is established prior to drilling. The drilling plan sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 2C illustrates a wireline operation being performed by wireline tool 106.3 suspended by rig 128 and into wellbore 136 of FIG. 2B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 2A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 2D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 2B-2D illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 2A-2D are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites.

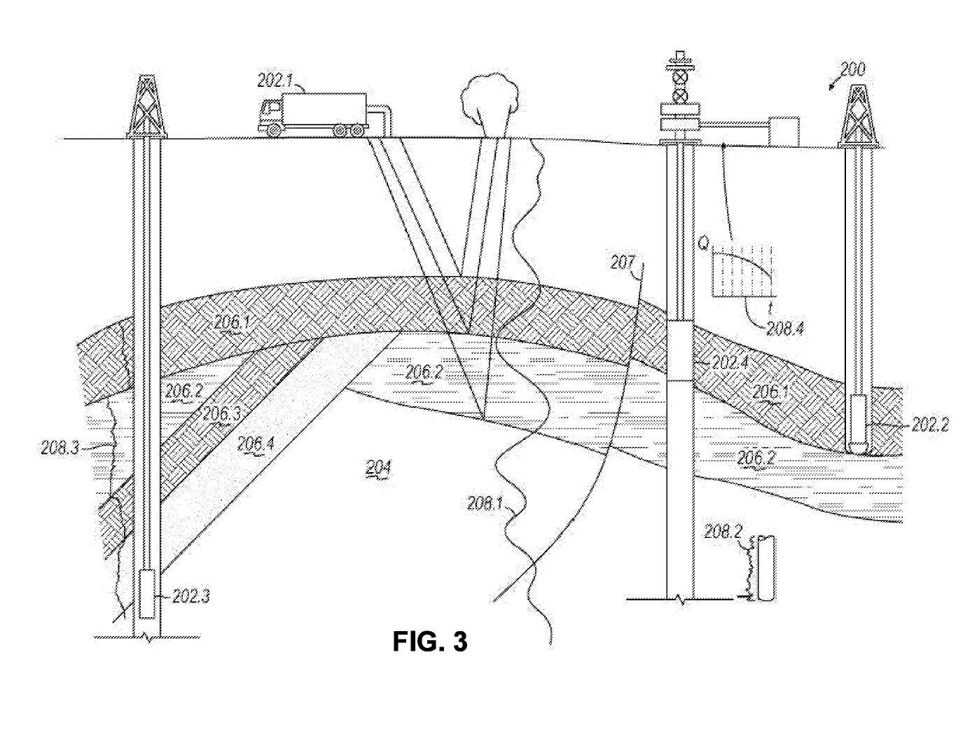

FIG. 3 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 2A-2D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that generally provides a resistivity or other measurement of the formation at various depths.

A production decline curve or graph 208.4 is a dynamic data plot of the fluid flow rate over time. The production decline curve generally provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, generally below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 3, may then be processed and/or evaluated. Generally, seismic data displayed in static data plot 208.1 from data acquisition tool 202.1 is used by a geophysicist to determine characteristics of the subterranean formations and features. The core data shown in static plot 208.2 and/or log data from well log 208.3 are generally used by a geologist to determine various characteristics of the subterranean formation. The production data from graph 208.4 is generally used by the reservoir engineer to determine fluid flow reservoir characteristics. The data analyzed by the geologist, geophysicist and the reservoir engineer may be analyzed using modeling techniques.

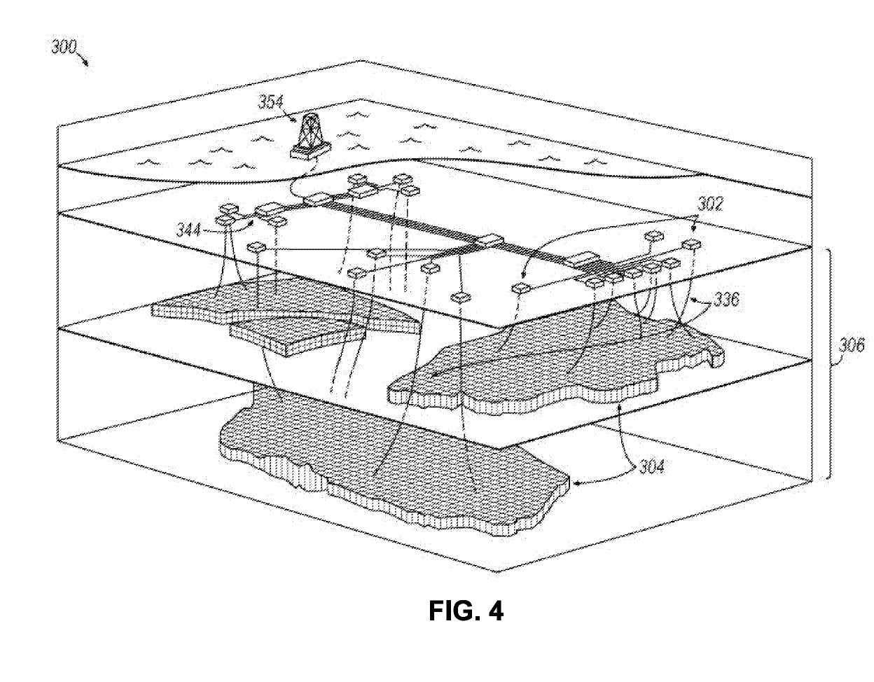

FIG. 4 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 4 is not intended to limit the scope of the oilfield application system. Part or all of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

### Completion Design Incorporating LWD Data

Embodiments consistent with the invention may be used to utilize LWD data collected during drilling to refine the design of one or more completions, including, in some embodiments, one or more flow control devices of one or more completions.

In some embodiments, for example, advanced wells & completions modeling workflows may be used in the design of one or more flow control devices of a completion based on integrating the sub-surface reservoir, production and completions design elements together within a coherent and consistent framework to develop and define well and reservoir deliverability against time. A flow control device may be considered to include various types of devices that may be utilized in a completion to control the inflow of fluid from a reservoir into a wellbore, including both passive and active devices. Examples include passive devices such as inflow control devices (ICDs), active devices such as inflow control valves (ICVs) and autonomous devices such as autonomous inflow control devices (AICDs), among others. In the embodiment illustrated hereinafter, an inflow control device (ICD) design process is described; however, it will be appreciated that the invention may be utilized in connection with other types of flow control devices, and the invention is therefore not limited to an ICD-specific design process.

In the hereinafter-illustrated ICD design process, for example, two phases may be used: planning and execution. The planning phase may utilize traditional ICD design modeling utilizing either a Well-Centric or Reservoir-Centric workflow, which generally may be carried out well in advance of operations, allowing the correct equipment to be ready at the wellsite. The execution phase incorporates the latest LWD measurements taken while drilling the horizontal portion of a well and utilizes them to update a reservoir model, allowing the previous ICD design to be optimized, and the actual hardware modified accordingly at the wellsite before it is deployed.

It will also be appreciated, however, that a design process may also be used in some embodiments for designing completions in which no flow control devices are used. In such embodiments, for example, the location(s) at which perforations are formed in a wellbore, as well as various characteristics of those perforations, may be optimized using similar operations discussed herein for optimizing flow control devices. Likewise, other design aspects of a completion, such as the use, placement and/or configuration of slotted liners or screens, what zones of a well are completed with blank pipe vs. pipe incorporating slots or openings, etc., may also be optimized using similar operations to those discussed herein for completion flow control device design. The manners in which such other types of completion optimizations may occur will be readily apparent to one of ordinary skill in the art having the benefit of the instant disclosure. Therefore it will be appreciated that embodiments of the invention may be used in general for completion design, whether or not a flow control device is incorporated into a completion. As such, while the discussion hereinafter will focus on an embodiment in which completion flow control device design is performed, the invention is not so limited.

### Planning Phase Workflow

In the planning phase, several different completion design workflows may be used, including, for example Well-Centric, Log Derived Properties Workflow; Well Centric, Geologically Derived Properties Workflow and Reservoir-Centric Workflow. Selection of a completion design workflow may be based, for example, on the data that is available for input, and the simulations may be performed using a numerical simulator such as the ECLIPSE or INTERSECT simulators available from Schlumberger Ltd. and its affiliates.

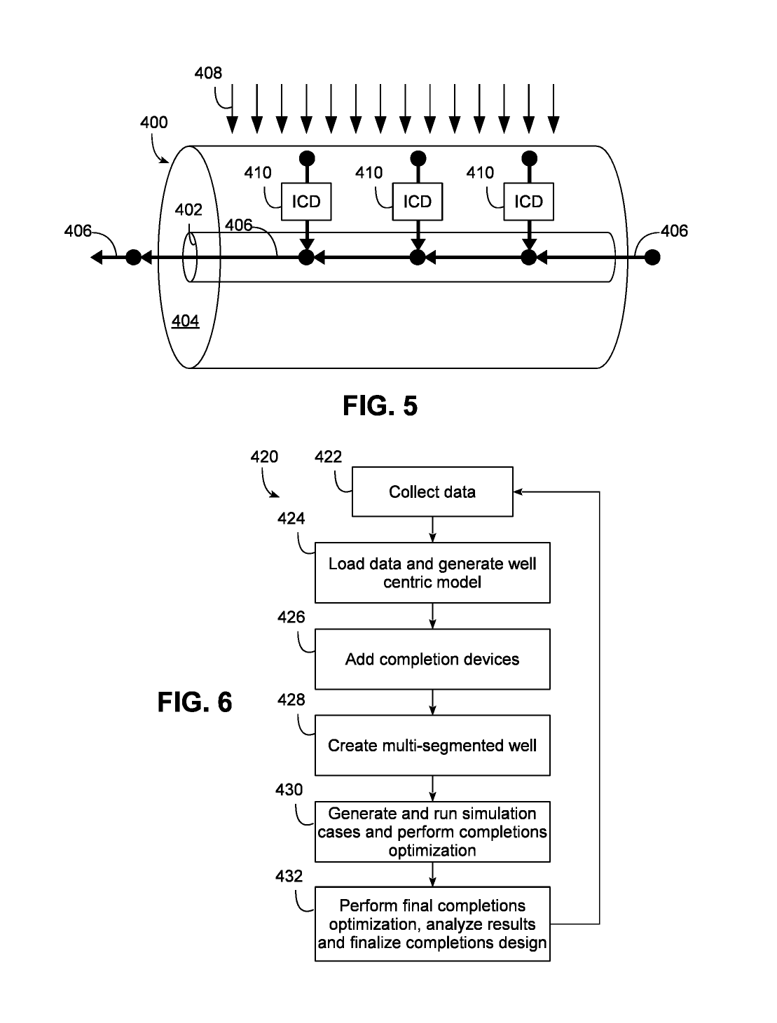

In this embodiment, flow control devices may be presented as individual segments in a multi-segmented model, as illustrated in FIG. 5. FIG. 5, in particular illustrates a portion of a well model 400 of a wellbore of the type including a casing or tubing 402 disposed within an annulus 404 of the wellbore, a plurality of segments 406 are defined, and inflow from the reservoir is represented by arrows 408. One or more flow control devices, here Inflow Control Devices (ICDs) 410, are modeled as individual segments in the model. Advantages of using a multi-segmented well model to simulate deviated and horizontal wells include, among others, an ability to calculate pressure drop due to friction and acceleration along the wellbore, more accurate calculation of a hydrostatic pressure gradient along the wellbore, as the well no longer lies along grid cell centers, an ability to determine multi-phase flow along the wellbore, an improved modeling of a cross flowing well, and an ability to model various downhole devices.

In a Well-Centric, Log-Derived Properties Workflow, a reservoir simulation model may be quickly built from collected logs or pseudo logs (i.e., logs generated from an already existing simulation model). An elliptical wellbore refined tartan or conventional corner-point grid skeleton may be built around the well, with the bulk dimensions of the grid set using length and width dimensions, plus a vertical thickness to construct a reservoir model for the well with an appropriate size and volume. The grid dimensions may also consider the location and type of the nearby wells, their production rates, formation and structural properties.

The grid block size in the direction of the well may be based on the nominal joint lengths of equipment used in the well but may also consider petrophysical and geological properties. The grid block sizes generally do not need to be uniform in the along well direction, allowing higher resolution (smaller grid blocks) near fractures or in sections with rapidly changing properties. Both the wellbore refined tartan and the conventional corner point grids generally offer the option to increase the grid block sizes away from the wellbore to reduce the number of grid blocks and hence run time. Permeability, water saturation, porosity and other properties may be upscaled and distributed to the simulation grid using conventional techniques. An aquifer may be used to provide pressure support.

Base case and ICD completions may be added to the simulator and producing boundary conditions may be defined to start the evaluation process against the defined objectives. Long-term production predictions are not generally valid for Well-Centric, Log Derived Properties models because of the simplified geological description and because the influence of other wells may not have been considered. However, when data or time is limited or when LWD log data only becomes available a few hours or days before the completion runs, they may be desirable in some instances.

An example implementation of a Well-Centric, Log-Derived Properties Workflow is illustrated at 420 in FIG. 6. Data (e.g., expected average permeability and porosity or logs, planned deviation surveys, pressure volume temperature (PVT) data, special core analysis (SCAL), etc.) may be collected in block 422, data (e.g., deviation survey, logs, etc.) may be loaded and a well-centric model (gridding and property population) may be generated in block 424. Next, completion devices, e.g., ICDs, FCVs, packers, etc., may be added (block 426) and a multi-segmented well may be created, e.g., automatically (block 428). Thereafter, simulation cases may be generated and run and completions optimization may be performed (block 430). Then, in block 432 final completions optimization may be performed, the results may be analyzed, and a final completion design may be determined. If necessary, and as illustrated by the arrow from block 432 to block 422, workflow 420 may be an iterative, multi-pass workflow in some instances.

In a Well-Centric, Geologically Derived Properties Workflow, a well-centric reservoir simulation model may be quickly built from an existing full-field model. A simulation grid skeleton may be built around a well with appropriate dimensions and a grid block size that gives sufficient resolution for near wellbore modeling. The structure, layering, properties, regions and other parameters may then be populated into the new Well-Centric model from the original simulation model making use of the available data.

Updating geological and reservoir simulation models from newly acquired LWD data using traditional techniques may take several days or weeks. The exact amount of time generally depends on many factors, including the complexity and existing understanding of the field, the consistency or otherwise of the new data with the existing model and the priority of the work. In wells where ICDs are used, a petro-physical interpretation may be fast-tracked and made available to help design the completion. When the fast-tracked LWD data becomes available, the model properties may be updated within a defined distance of the well for the reservoir layer or layers in which the well is landed. This improves the inflow performance model for the well while keeping the structure and flow behavior from the original simulation model. Geological and petrophysical input to this process may be used, generally both during the update and in the planning sessions conducted beforehand.

Base case and ICD completions may be added to the simulator with producing boundary conditions to start the evaluation process against the defined objectives. In addition, the completion design process for the Well-Centric, Geologically Derived Properties Workflow may use production profiles versus time although longer-term limitations may be considered. As part of the quality control process, production profiles for an open hole completion may be compared between the new and full-field models.

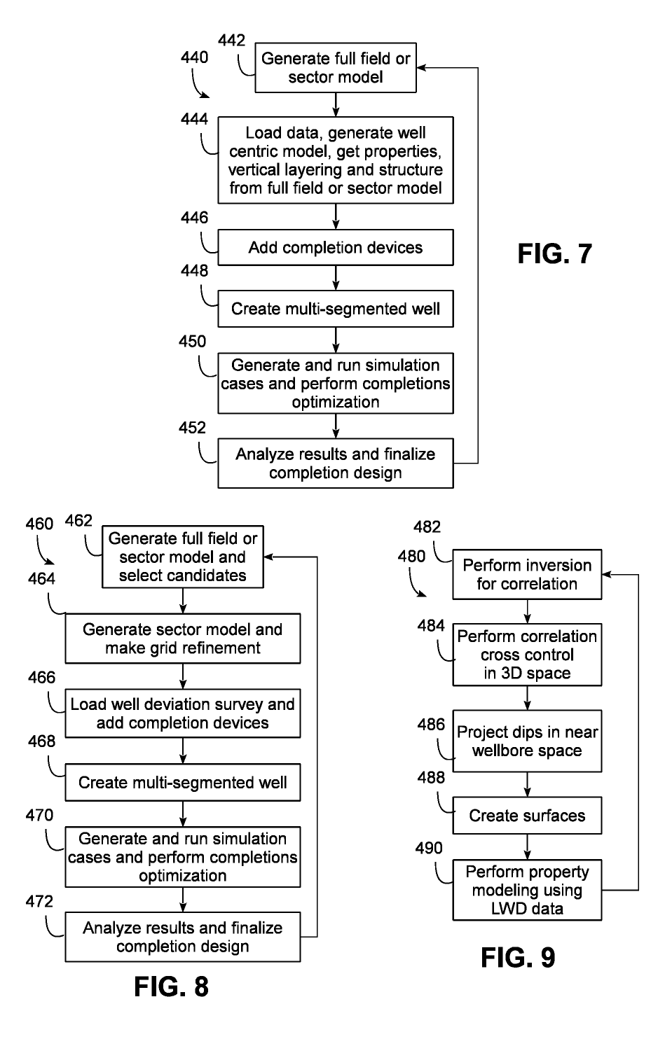

An example implementation of a Well-Centric, Geologically Derived Properties Workflow is illustrated at 440 in FIG. 7. A full field or sector model (e.g., including wells, PVT data, SCAL data, VFP data, etc.) may be generated (block 442). In block 444, data (e.g., a deviation survey) may be loaded, a well-centric model (gridding) may be generated, with properties, vertical layering and structure obtained from the full field or sector model. Next, completion devices, e.g., ICDs, FCVs, packers, etc., may be added (block 446) and a multi-segmented well may be created, e.g., automatically (block 448). Thereafter, simulation cases may be generated and run and completions optimization may be performed (block 450). Then, in block 452 the results may be analyzed and a final completion design may be determined. If necessary, and as illustrated by the arrow from block 452 to block 442, workflow 440 may be an iterative, multi-pass workflow in some instances.

A Reservoir-Centric Workflow may use a sector simulation model or sector model. Sector modeling simulates a selected part of the full field reservoir model by using either flux (fluid flow) or pressure boundary conditions extracted from the full field model. Local grid refinement may be applied to the target well(s), or even the whole sector model to allow advanced well completions to be accurately modeled. Sector models may be desirable for evaluating ICD or other advanced completion options because they generally run much faster than a full field model, even with local grid refinement.

A Reservoir-Centric Workflow may be desirable in some embodiments if the problem involves injection and production wells that are clearly connected or when multiple wells interfere with, or affect each other. Long-term production or injection behavior in sector models may be comparable to full field model predictions given local grid refinement. Completions may be evaluated (optimized) using production profile based objective functions in the Reservoir-Centric Workflow. This modeling workflow may take longer than the Well-Centric workflows but may provide more accurate results if the time and resources are available.

An example implementation of a Reservoir-Centric Workflow is illustrated at 460 in FIG. 8. A full field or sector model (e.g., including wells, PVT data, SCAL data, VFP data, etc.) may be generated and candidates selected (block 462). In block 464, a sector model may be generated and grid refinements may be made. Next, in block 466, data (e.g., a well deviation survey) may be loaded and completion devices, e.g., ICDs, FCVs, packers, etc., may be added. Next, a multi-segmented well may be created, e.g., automatically (block 468). Thereafter, simulation cases may be generated and run and completions optimization may be performed (block 470). Then, in block 472 the results may be analyzed and a final completion design may be determined. If necessary, and as illustrated by the arrow from block 472 to block 462, workflow 460 may be an iterative, multi-pass workflow in some instances.

### Execution Phase Workflow

The execution phase builds upon the modeling conducted in the planning phase; the addition of LWD data to refine a structural model to generate a locally enhanced reservoir model and petrophysical properties allows for an optimized ICD design. The execution phase may be performed in some embodiments even when the completions run is scheduled to be within a short duration after the drilling run. This additional locally enhanced reservoir model generation may also be conducted within a PETREL environment in some embodiments, allowing for the result to be quickly and easily integrated with the original reservoir model. It will be appreciated that conventional structural models generally include only geometrical data; however, in some embodiments of the invention, a structural model may be additionally populated with one or more properties (e.g., formulation and/or fluid properties), as will become more apparent below, to generate what is referred to herein as a locally enhanced reservoir model.

The execution phase may rely on various types of LWD data to update a structural model to a desired level of detail, and therefore it may be desirable in some embodiments to utilize one or more LWD tools in a drilling BHA, e.g., one or more of the GeoSphere, EcoScope, and MicroScope/GVR may be used in a BHA to collect LWD data during a drilling operation.

In one embodiment, for example, three LWD inputs may be used to update and optimize a completion design. First, the inversion output from a GeoSphere tool may be used. The GeoSphere reservoir-mapping-while-drilling tool, which is a type of deep directional resistivity (DDR) tool, is a deep reading azimuthal resistivity tool having an enhanced depth of investigation (e.g., about 100 feet or more around a wellbore) based upon tool frequency and transmitter spacings combined with the ability to produce a multilayer inversion. Using the GeoSphere tool, the geological structure of the reservoir may be mapped, and fluid contacts may be interpreted, generally in real-time, thereby providing a new image of the subsurface reservoir structure on the seismic scale.

Second, LWD images from either a GVR (resistivity) tool or EcoScope (Density) tool (or other tools capable of producing wellbore images) may be used. These LWD images may be interpreted and the resulting dips may allow for the characterization of the structural dips and faults, and the computation of the True Stratigraphic Thickness (TST) to aid correlation. A near-wellbore structural model, referred to herein as a locally enhanced reservoir model, may therefore be created from the LWD images and the deep directional resistivity (DDR) information, as discussed in greater detail below.

Third, for filling in the properties in the locally enhanced reservoir model, GR, Resistivity, Neutron and Density measurements from the EcoScope tool may be used. These triple-combo LWD measurements may be analyzed to produce gas/oil/water zones differentiation, measure porosity, permeability and water saturation, generally through Petrophysical analysis like Archie's law. NMR measurements with the ProVision+ tool may also be used to complement the EcoScope tool to estimate permeability. The StethoScope tool may also be used for pressure sampling while drilling to update, or increase the confidence in, the reservoir pressure and fluid model. Each of the aforementioned tools are available from Schlumberger Ltd. and its affiliates.

It will be appreciated that various types of LWD data may be used in different embodiments, including, for example, resistivity, porosity, density, etc. It will also be appreciated that various types of data or information may be derived from such LWD data, including geological structure data, fluid contact data, structural dip data, derived permeability, etc. As such, the invention is not limited to the particular tools and/or LWD data discussed herein.

Based upon the aforementioned LWD data, a workflow may be used to generate a three dimensional (3D) near well structural model, or locally enhanced reservoir model, e.g., utilizing the point set data output from the inversion from DDR tool data (e.g., a geological boundary or a fluid contact) and the structural dip data picked from an LWD image. These inputs may then be combined to create surfaces and fault stick objects within the PETREL environment. The resultant surface and other objects may then be utilized as inputs to a corner point gridding workflow in order to create a 3D grid. This locally enhanced reservoir model may then be populated with LWD derived properties such as porosity and permeability utilizing a property modeling function. In one embodiment, this locally enhanced reservoir modeling workflow combines the multiple scales of analysis of the borehole imaging and DDR tools and takes the benefit of the accuracy and spatial resolution of these measurements for offering high resolution of the property distributions.

An example implementation of a workflow 480 for generating a 3D near well structural model, or locally enhanced reservoir model, is illustrated in FIG. 9, and includes performing an inversion for correlation (block 482), performing a correlation cross control in 3D space (block 484), projecting dips in the near wellbore space (block 486), creating surfaces (block 488) and performing property modeling using the LWD data (block 490).

Thereafter, the LWD-based locally enhanced reservoir model may be used to update the reservoir model utilized in the planning phase, focusing on a zoned section (e.g., as specified by the client). The manner in which this is performed may vary depending on factors such as reservoir geology, how different the LWD generated model is from the original, how much the new data should influence the original model, etc. In some embodiments, the full field model may be updated at a later stage if desired.

Once the update to the reservoir model is completed, a reservoir simulation may be re-run and any desirable changes to the ICD design may be implemented at the rig site. For example, information from a DDR tool about the location of water closer to the wellbore than expected may allow for an optimized design to mitigate the risk of early water breakthrough by identifying the likely route of the water through the more porous layers, potentially delaying water production and improving the productivity of the well. Design changes of this nature may include, for example, varying the depth/location and/or size of the nozzles of one or more ICDs, as well as other design changes that will be apparent to one of ordinary skill in the art having the benefit of the instant disclosure.

Additional benefits of the aforementioned dual phase design process include incorporation of most if not all of the relevant data that is useful for optimizing ICD design, maximization of the life of a well through water delay, improving reservoir sweep, and, through the use of both planning and execution phases, an ability to plan for all desired equipment to be shipped to the wellsite, while still allowing for a design to be optimized based upon data generated during drilling.

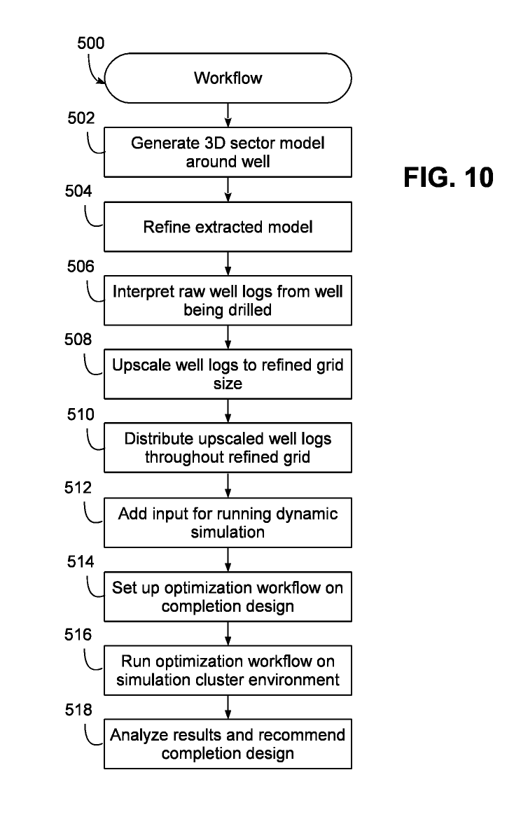

Now turning to FIG. 10, an example workflow 500 implemented in the PETREL environment is further illustrated. In block 502, a 3D sector model may be generated from a pre-job reservoir model, which may include faults, structure, etc., or may be created as a simple grid model around the well. Next, in block 504, the extracted model may be refined, e.g., by using a grid refinement process, by creating a local grid refinement (LGR) around the well, or by creating an unstructured LGR around the well. Next, in block 506, raw well logs from the well being drilled are interpreted, e.g., porosity and permeability logs, and in some instances, water saturation logs.

Next, in block 508, well logs are upscaled to the refined grid size, and in block 510 the upscaled well logs are distributed throughout the refined grid. Next, in block 512, any data desired for running a dynamic simulation is input, including, for example, pressure, volume, temperature (PVT) data with contacts, capillary pressure (Pc) curve data, special core analysis laboratory (SCAL) data, vertical lift performance (VFP) data, and/or well controls. Then, in block 514, an optimization workflow on completion design is set up using an uncertainty and optimization (U&O) process, e.g., to optimize oil production, minimum water production, NPV, etc. by varying compartment length, number of valves, nozzle size/flow area, etc., and in block 516 the optimization workflow is run on a simulation cluster environment, e.g., using the ECLIPSE or INTERSECT numerical simulator. Then, based on the results of the optimization, results are analyzed and a completion design is recommended in block 518.

In one embodiment, LWD data may be used to generate a locally enhanced reservoir model using the PETREL environment. It may be desirable, for example, to export a multilayer inversion result as a point set of x, y and z values tied to resistivity values, along with DDR 3-dimensional information and an interpretation of the multilayer inversion result. Then, longitudinal and transverse structural dips may be created for manually interpreted surfaces and thereafter imported into the PETREL environment. The newly imported dips may then be assigned to a dipset classification, and in some instances, the dips may be selectively filtered. Thereafter, axis, segment dips of the longitudinal and transverse dips may be merged together to make a plane dip, and horizon structural dips may be assigned to PeriScope dispsets. At this point, a structural modeling workflow may be continued, in a manner that will be appreciated by one of ordinary skill in the art having the benefit of the instant disclosure.

In some embodiments, at least portions of the aforementioned workflows may be performed in an automated fashion by an optimizer, e.g., as may be implemented as a petro-technical module 32 (FIG. 1). An optimizer may be configured, for example, to receive as input a set of one or more completions comprising an initial completion design, along with a structural model. The optimizer may then vary aspects of the initial completion design and run simulations to optimize against an objective function (e.g., an indication of production, an indication of potential water breakthrough, etc.). The optimizer may, in an automated, iterative and in some instances structured manner, vary aspects of the initial completion design such as numbers of flow control devices and/or completions, positions of flow control devices and/or completions, positions and/or numbers of packers, varying the depth/location and/or size and/or number of the nozzles in a flow control device, etc. In some instances, the optimizer may operate to maximize production and/or minimize the risk of early water breakthrough, or otherwise iteratively evaluate changes against an objective function based upon simulation results. It will be appreciated that implementation of an optimizer to provide the aforementioned functionality would be well within the abilities of one of ordinary skill in the art having the benefit of the instant disclosure.

While particular embodiments have been described, it is not intended that the invention be limited thereto, as it is intended that the invention be as broad in scope as the art will allow and that the specification be read likewise. It will therefore be appreciated by those skilled in the art that yet other modifications could be made without deviating from its spirit and scope as claimed.

What is claimed is:

1. A method of completion design, comprising:
receiving logging while drilling (LWD) data collected during drilling of a wellbore into a reservoir;
generating a locally enhanced reservoir model of at least a portion of the reservoir proximate the wellbore based upon the received LWD data; and
optimizing a design of at least one completion for the wellbore based upon the generated locally enhanced reservoir model.

2. The method of claim 1, wherein the LWD data includes resistivity data collected from a deep directional resistivity tool.

3. The method of claim 2, wherein the LWD data includes structural data and/or fluid contact data generated from an inversion of an output of the deep directional resistivity tool.

4. The method of claim 3, wherein the LWD data includes structural dip data.

5. The method of claim 1, wherein generating the locally enhanced reservoir model comprises generating the locally enhanced reservoir from a near well structural model.

6. The method of claim 1, wherein optimizing the design includes varying a depth and/or a flow area for at least one flow control device in the at least one completion, changing a number of flow control devices and/or completions or changing a location of a flow control device and/or a completion based upon the generated locally enhanced reservoir model.

7. The method of claim 1, wherein optimizing the design further includes automatically and iteratively varying the design, running a simulation using the varied design and comparing a result of the simulation based upon an objective function.

8. The method of claim 1, wherein optimizing the design includes changing a water contact height based upon the generated locally enhanced reservoir model.

9. The method of claim 1, further comprising in an execution phase using the generated locally enhanced reservoir model to refine a reservoir model used to generate an initial well plan for the wellbore during a planning phase, wherein optimizing the design includes refining an initial design generated during the planning phase using the reservoir model.

10. The method of claim 1, wherein generating the locally enhanced reservoir model includes populating a structural model with one or both of formation and fluid properties.

11. An apparatus, comprising:
at least one processing unit; and
program code configured upon execution by the at least one processing unit to receive logging while drilling (LWD) data collected during drilling of a wellbore into a reservoir, generate a locally enhanced reservoir model of at least a portion of the reservoir proximate the wellbore based upon the received LWD data, and optimize a design of at least one completion for the wellbore based upon the generated locally enhanced reservoir model.

12. The apparatus of claim 11, wherein the LWD data includes resistivity data collected from a deep directional resistivity tool.

13. The apparatus of claim 12, wherein the LWD data includes structural data and/or fluid contact data generated from an inversion of an output of the deep directional resistivity tool.

14. The apparatus of claim 13, wherein the LWD data includes structural dip data.

15. The apparatus of claim 11, wherein the program code is configured to generate the locally enhanced reservoir model from a near well structural model.

16. The apparatus of claim 11, wherein the program code is configured to optimize the design by varying at least one of a depth and a flow area for at least one flow control device of the at least one completion based upon the generated locally enhanced reservoir model.

17. The apparatus of claim 11, wherein the program code is configured to optimize the design further by automatically and iteratively varying the design, running a simulation using the varied design and comparing a result of the simulation based upon an objective function.

18. The apparatus of claim 11, wherein the program code is configured to optimize the design by changing a water contact height based upon the generated locally enhanced reservoir model.

19. The apparatus of claim 11, wherein the program code is further configured to, in an execution phase, use the generated locally enhanced reservoir model to refine a reservoir model used to generate an initial well plan for the wellbore during a planning phase, and wherein the program code is configured to optimize the design by refining an initial design generated during the planning phase using the reservoir model.

20. The apparatus of claim 11, wherein the program code is configured to generate the locally enhanced reservoir model by populating a structural model with one or both of formation and fluid properties.

21. A program product, comprising:
a computer readable medium; and
program code stored on the computer readable medium and configured upon execution by at least one processing unit to receive logging while drilling (LWD) data collected during drilling of a wellbore into a reservoir, generate a locally enhanced reservoir model of at least a portion of the reservoir proximate the wellbore based upon the received LWD data, and optimize a design of at least completion for the wellbore based upon the generated locally enhanced reservoir model.
